(19) United States
(12) Patent Application Publication
(10) Pub. No.: US 2015/0088736 A1
(43) Pub. Date: Mar. 26, 2015

(54) METHOD, APPARATUS AND RECORDING MEDIUM FOR SUPPORTING ELECTRONIC PAYMENT

(71) Applicant: Samsung Electronics Co., Ltd., Gyeonggi-do (KR)

(72) Inventors: Mun-Sik Bu, Gyeonggi-do (KR); Jin-Wan Choi, Gyeonggi-do (KR)

(73) Assignee: Samsung Electronics Co., Ltd., Gyeonggi-do (KR)

(21) Appl. No.: 14/293,872

(22) Filed: Jun. 2, 2014

(30) Foreign Application Priority Data
Sep. 23, 2013 (KR) 10-2013-0112900

(51) Int. Cl. G06Q 20/36

(52) U.S. Cl. CPC G06Q 20/367
USPC 705/41

(57) ABSTRACT

A method comprises receiving user payment information including a user identifier for paying for an item from a user terminal or a shop payment terminal, determining at least one payment mean available at the payment terminal based on a shop payment information database, comparing payment conditions when two or more payment means are available, and transmitting the prioritized payment means based on a result of the comparison to the user terminal or the shop payment terminal. An electronic wallet server comprises a controller configured to compare payment conditions when two or more payment means are available, and cause the transceiver to transmit prioritized payment means based on a result of the comparison to the user terminal or the shop payment terminal.

### CROSS-REFERENCE TO RELATED APPLICATION AND CLAIM OF PRIORITY

The present application is related to and claims the benefit under 35 U.S.C. §119(a) of a Korean patent application No. 10-2013-0112900 filed in the Korean Intellectual Property Office on Sep. 23, 2013, the entire disclosure of which is incorporated herein by reference.

### TECHNICAL FIELD

The present disclosure relates generally to an electronic wallet server for providing payment-related information using an electronic wallet installed in a user terminal, a system and method for providing payment information using the electronic wallet, and a computer readable recording medium.

### BACKGROUND

The credit card market structure can be classified into a three-party system in which three parties of, generally, a card member, a card member shop, and a credit card company participate in transactions to accomplish the transactions, and a four-party system in which transactions are accomplished through four parties of a card issuer and an acquirer specialized from a credit card company, a card member, and a card member shop. In an example of the three-party system, a Value Add Network (VAN) company can provide authorizations of card transactions between a card company and a card member shop, and recruit and manage card member shops.

A payment process through the credit card can be divided into three steps of a credit card authorization between a card member and a card member shop, payment (acquiring) between the card member shop and a card company, and payment collection between the card company and the card member.

If a card member presents his/her credit card at a card member shop in order to purchase a product or a service, and a terminal (e.g., a Point Of Sale terminal) of the card member shop scans the credit card, transaction information of the credit card is transmitted to a VAN company. The VAN company transmits the transaction information to a card company, and requests the card company to authorize the transaction. Thereafter, if a transaction authorization from the card company is notified to the terminal of the card member shop through the VAN company, the card member shop sells the product or service to the card member because the credit card has been normally authorized. The above-described process is the credit card authorization between the card member and the card member shop.

Thereafter, the card member shop transmits a sales slip (that is, sales data) on which the card member wrote down his/her signature to the card company through the VAN company, and the card company examines the sales slip received from the card member shop. If the card company determines that the sales slip has been normally processed, the card company puts the credit sales money into the card member shop's account. The above-described process is the payment (acquiring) between the card member shop and the card company, commonly called “acquiring sales slips”.

In more detail, the card company subtracts a merchant fee, an installment commission, etc. from the credit sales money (a definite amount of acquiring) to calculate an amount for deposit, and transmits data regarding the amount for deposit to the card company's bank. Then, the card company's bank puts the amount for deposit into the card member shop's account via automatic withdrawal.

In the payment collection between the card company and the card member, the card company asks the card member to make a credit card payment until the card member's payment due date, and if the card member puts money for payment into his/her bank account after checking a statement received from the card company, the card company withdraws the money from the card member's bank account, thereby completing the procedure of payment.

Meanwhile, in case of online transactions, since credit card transactions are processed by receiving and transmitting credit card transactions information through the Internet, telephones, mails, etc. without a face-to-face between buyers and sellers, a Payment Gateway (PG) company can participate in a transaction process to perform a function similar to the VAN company in order to efficiently intermediate and secure information about credit card transactions.

However, in the related art, since discount information associated with payment is provided without taking individual users into consideration, a user should himself/herself seek optimal discount information to make a payment. Furthermore, even when the user finds optimal discount information, the user cannot make a payment if he/she does not own the corresponding payment means.

The above information is presented as background information only to assist with an understanding of the present disclosure. No determination has been made, and no assertion is made, as to whether any of the above might be applicable as prior art with regard to the present disclosure.

### SUMMARY

A method for supporting electronic payment using an electronic wallet comprises receiving user payment information including a user identifier for paying for an item from a user terminal or a shop payment terminal, determining at least one payment mean available at the payment terminal based on a shop payment information database, retrieving each payment condition with respect to at least one payment mean for the item, based on at least one of the user payment information and the shop payment information database, comparing payment conditions when two or more payment means are available, and transmitting the prioritized payment means based on a result of the comparison to the user terminal or the shop payment terminal.

In certain embodiments, the user payment information received from the shop terminal includes at least one of the user identifier, information on the shop, information on an amount of payment, information about the item, and information on payment means.

In certain embodiments, the payment conditions comprise at least one of information on cards, discount of the cards, available points, and available gift coupons.

In certain embodiments, the compared payment conditions comprises one of amounts of payment with respect to each payment mean, amounts of payment in consideration of available points or gift coupon, and amounts of points to be earned upon a payment.

In certain embodiments, comparing of the payment conditions comprises digitizing the payment conditions to compare the digitized payment conditions.

In certain embodiments, comparing of the payment conditions comprises weighting each payment condition, and comparing of the weighted payment conditions.

In certain embodiments, the payment means are prioritized in ascending order of amounts of payments.

In certain embodiments, the payment means are prioritized in ascending order of amounts of earning points.

In certain embodiments, the payment means are prioritized in descending order of discount rates.

An electronic wallet server comprises a shop information database configured to store shop payment information of at least one shop, a user information database configured to store user payment information of each user with respect to respective user identifiers, a transceiver configured to receive user payment information including the user identifier from either a user terminal or a shop terminal, and a controller configured to retrieve each payment condition with respect to at least one payment mean for the item, based on at least one of the user payment information and the shop payment information database, compare payment conditions when two or more payment means are available, and cause the transceiver to transmit prioritized payment means based on a result of the comparison to the user terminal or the shop payment terminal.

On the other hand, information about the method of providing the payment information using the electronic wallet can be stored in a computer-readable recording medium. The computer-readable recording medium can include all kinds of recording medium in which programs and data can be stored to be readable by a computer system. Examples of the computer-readable recoding medium are Read-Only Memory (ROM), Random Access Memory (RAM), Compact Disk (CD), Digital Video Disk-Read Only Memory (DVD-ROM), magnetic tapes, floppy disks, optical data storage devices, and an embedded Multi Media Card (eMMC), and can be also implemented in the form of a carrier wave (for example, transmission through the Internet). Further, the computer readable recording medium can also be distributed over network coupled computer systems so that the computer readable code is stored and executed in a distributed fashion.

Other aspects, advantages, and salient features of the disclosure will become apparent to those skilled in the art from the following detailed description, which, taken in conjunction with the annexed drawings, discloses exemplary embodiments of the disclosure.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 is a block diagram illustrating a payment system according to embodiments of the present disclosure;

FIG. 2 describes a payment procedure through a member shop terminal;

FIG. 3 describes an online payment procedure through the Internet;

FIG. 4 illustrates a payment system according to an embodiment of the present disclosure;

FIG. 5 is a block diagram illustrating a configuration of an electronic wallet server according to an embodiment of the present disclosure;

FIG. 6 is a block diagram illustrating a configuration of a user terminal according to an embodiment of the present disclosure;

FIG. 7 is a flowchart illustrating a method of making a payment using an electronic wallet, according to an embodiment of the present disclosure;

FIG. 8 is a flowchart illustrating a method in which an electronic wallet server processes a payment, according to an embodiment of the present disclosure;

FIG. 9 is a flowchart illustrating a method in which a user terminal processes a payment, according to an embodiment of the present disclosure;

FIG. 10 is a flowchart illustrating a method in which an electronic wallet server provides payment information, according to an embodiment of the present disclosure;

FIG. 11 is a flowchart illustrating a method in which a user terminal provides payment information, according to another embodiment of the present disclosure; and

FIG. 12 is a block diagram illustrating a configuration of a user terminal according to an embodiment of the present disclosure.

Throughout the drawings, like reference numerals will be understood to refer to like parts, components, and structures.

### DETAILED DESCRIPTION

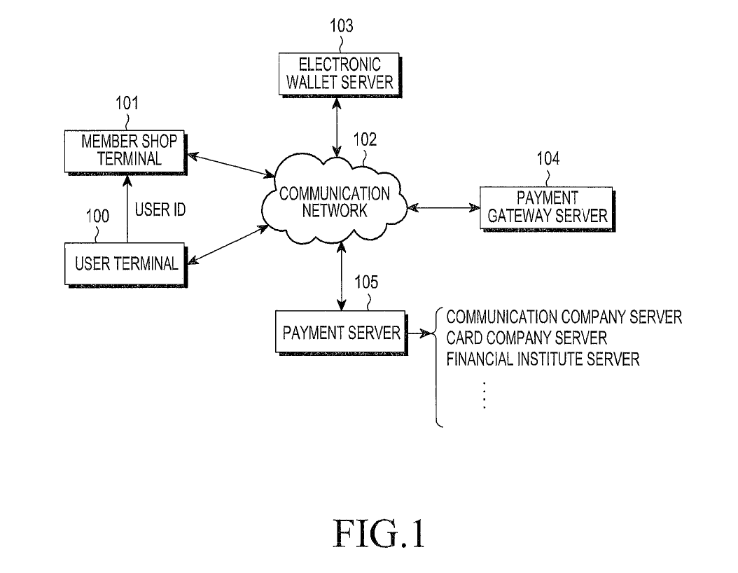

FIGS. 1 through 12, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged electronic devices. Example embodiments of the present disclosure are disclosed herein. However, specific structural and functional details disclosed herein are merely representative for purposes of describing example embodiments of the present disclosure, however, example embodiments of the present disclosure may be embodied in many alternate forms and should not be construed as limited to example embodiments of the present disclosure set forth herein.

Accordingly, while the disclosure is susceptible to various modifications and alternative forms, specific embodiments thereof are shown by way of example in the drawings and will herein be described in detail. It should be understood, however, that there is no intent to limit the disclosure to the particular forms disclosed, but on the contrary, the disclosure is to cover all modifications, equivalents, and alternatives falling within the spirit and scope of the disclosure.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present disclosure. As used herein, the term “and/or” includes any and all combinations of one or more of the associated listed items.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Embodiments of the present disclosure provide a system and method for making a payment using an electronic wallet, capable of effectively making a payment by combining offline payment means with an online payment procedure.

According to an embodiment of the present disclosure, payment means available at an offline member shop at which a user wants to make a payment is provided to the user terminal, so that a payment procedure can be done at the offline member shop through the user terminal. To do this, by allocating a user Identifier (ID) to each user, and causing a member shop terminal to transmit the user ID to an electronic wallet server, payment information of the member shop and payment information of the user may be analyzed.

According to an embodiment of the present disclosure, optimal discount information available at a member shop at which a user wants to make a payment may be provided using the user ID, and payment means may be recommended. For example, according to an embodiment of the present disclosure, when a payment is made, payment means information about at least one payment means, and additional information (e.g., optimal discount information) corresponding to the payment means may be provided.

Meanwhile, in the following description for embodiments of the present disclosure, the term “user terminal” may be a device with at least one processor, including a camera, a portable device, a mobile terminal, a communication terminal, a portable communication terminal, and a portable mobile terminal. For example, the user terminal may be a digital camera, a smart phone, a mobile phone, a game, a television (TV), a display device, a head unit for vehicle, a notebook computer, a laptop computer, a tablet computer, a Personal Media Player (PMP), Personal Digital Assistants (PDA), a navigation system, an Automated Teller Machine (ATM), or a Point Of Sales (POS) terminal. Also, the user terminal may be a flexible device or a flexible display device. Also, the user terminal may be a wearable device (e.g., a watch-type device, a glasses-type device, and a clothes-type device).

Also, in the following description for the embodiments of the present disclosure, the term “member shop” is defined for convenience of description, and the embodiments of the present disclosure can be applied to a general “shop”. Accordingly, the embodiments of the present disclosure are not limited to be applied to a specific kind of shop (e.g., a member store).

Hereinafter, embodiments of the present disclosure will be described in detail with reference to the appended drawings so that one of ordinary skill in the art can easily practice the present disclosure.

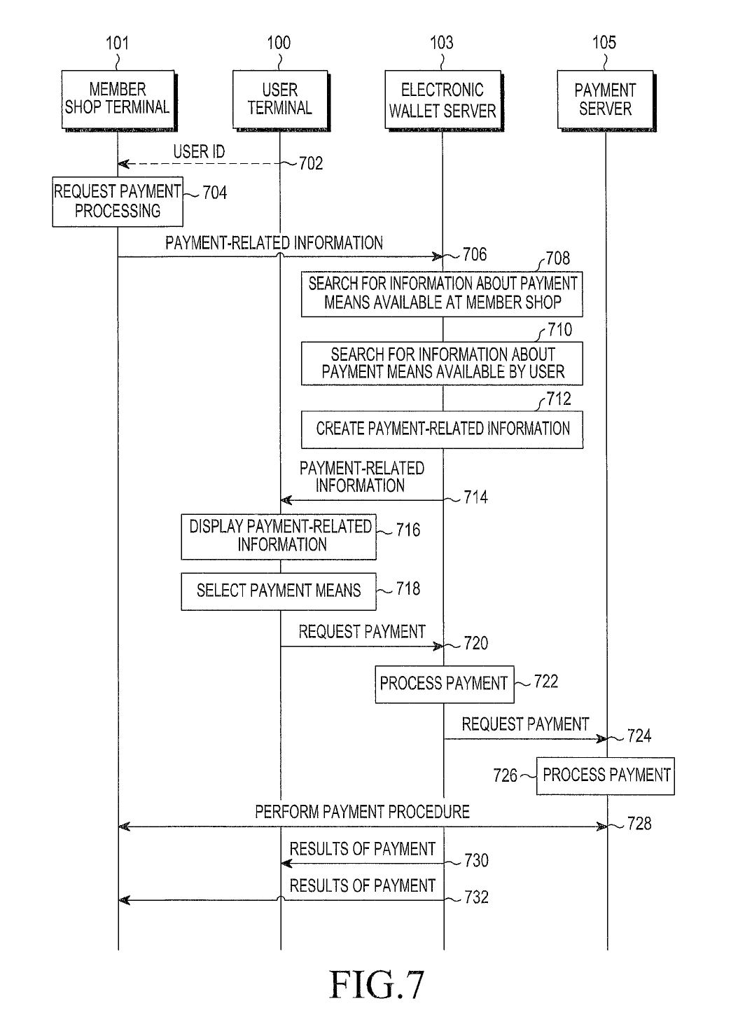

First, configurations of a system and an apparatus according to embodiments of the present disclosure will be described with reference to FIGS. 1 to 6, and then, methods according to embodiments of the present disclosure will be described in detail with reference to FIGS. 7 to 11.

FIG. 1 is a block diagram illustrating a payment system according to an embodiment of the present disclosure. Referring to FIG. 1, the payment system can be configured to include at least one of a user terminal 100, a member shop terminal 101, an electronic wallet server 103, a payment gateway server 104, and a payment server 105. The components of the payment system can connect to each other through a communication network 102.

When a user wants to purchase a product or a service and pay the purchase money at a member shop, the member shop terminal 101 (e.g., a POS terminal) installed in the member shop can be used to make the payment.

At this time, according to an embodiment of the present disclosure, by inputting the user IDentifier (ID) allocated in advance to the user to the member shop terminal 101, a payment through the electronic wallet server 103 can be made.

There are various methods of inputting the user ID to the member shop terminal 101. For example, the user ID can be input directly through an input device (e.g., input buttons or a touch screen) provided in the member shop terminal 101. As another example, the user ID stored in the user terminal 100 can be transmitted to the member shop terminal 101 through a short-range wireless communication device (e.g., a Near Field Communication (NFC) device). As still another example, a barcode stored as the user ID in the user terminal 100 can be displayed on the screen of the user terminal 100, and a barcode scanner included in the member shop terminal 101 can scan the barcode. The user ID can be account information set in advance to identify the user. The user ID can be any information by which the user can be identified. For example, the user ID can be configured with one(s) selected from among a numeral(s), a character(s), and a symbol(s), or with a combination of one or more of a numeral(s), a character(s), and a symbol(s). However, the user ID is not limited to the above-mentioned information.

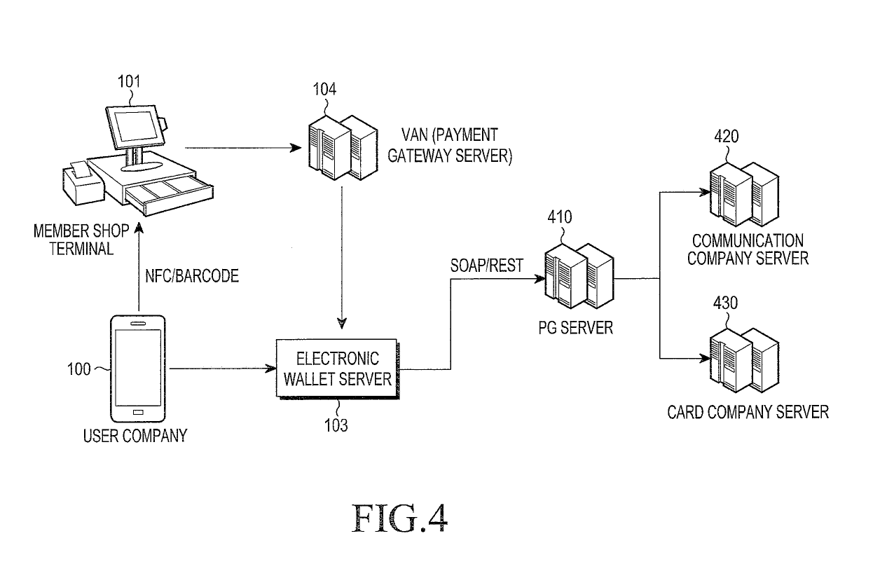

As such, if the user ID is entered to the member shop terminal 101, the user ID can be transmitted to the electronic wallet server 103 through the communication network 102. At this time, as illustrated in FIG. 4, the user ID can be transmitted to the electronic wallet server 103 via the payment gateway server 104 (e.g., a POS gateway server such as a VAN company's server).

The member shop terminal 101 can transmit payment-related information (e.g., information about the member shop, information about an amount of payment, information about the product or service to be purchased, and information about payment means) to the electronic wallet server 103, together with the user ID.

The electronic wallet server 103 that has received the user ID from the member shop terminal 101 can search for user payment-related information (e.g., information about available payment means) set in advance by the user, based on the user ID. Also, the electronic wallet server 103 can search for member shop payment-related information (e.g., information about available payment means) of the member shop. Accordingly, the electronic wallet server 103 can provide the user payment-related information and/or the member shop payment-related information to the user terminal 100 so that the payment can be made through the user terminal 100.

According to another embodiment of the present disclosure, since the electronic wallet server 103 knows information about payment means available at the corresponding member shop and information about the corresponding user's available payment means, the electronic wallet server 103 can transmit information about available payment means by which the user can make the payment at the member shop to the user terminal 100, with reference to the information about the payment means available at the corresponding member shop and the information about the corresponding user's available payment means, so that the payment can be more effectively made. According to still another embodiment of the present disclosure, when the individual payment means available by the user have different discount rates or benefits that are provided by the corresponding member shop, the electronic wallet server 103 can provide information about payment means providing a highest discount rate or most benefits to the user terminal 100 in order to recommend the payment means for the user.

For example, according to an embodiment of the present disclosure, the electronic wallet server 103 can calculate a discount rate for each of the user's available payment means, extracts optimal discount information for each of the user's available payment means, and provide the optimal discount information to the user terminal 100. According to another embodiment of the present disclosure, the electronic wallet server 103 can extract optimal discount information for each of the payment means available at the corresponding member shop, and provide the optimal discount information to the user terminal 100. According to still another embodiment of the present disclosure, the electronic wallet server 103 can provide information about payment means capable of collecting most points to the user terminal 100.

In this way, the user terminal 100 can receive the information about available payment means or the optimal discount information from the electronic wallet server 103, and display the information about available payment means or the optimal discount information on a screen. The user can see the information about available payment means or the optimal discount information displayed on the screen, and select desired payment means from among the available payment means to request a payment.

The user terminal 100 can transmit information for requesting a payment by the selected payment means to the electronic wallet server 103, according to the payment request from the user. The electronic wallet server 103 that has received the information for requesting the payment can perform a payment procedure through the payment server 105, according to the payment request.

In FIG. 1, the payment server 105 does not mean a specific server, but mean any server capable of performing payment-related processing. Accordingly, the payment server 105 can include various kinds of servers, such as a communication company server, a card company server, and a financial institution server, for performing payment-related processing according to a payment method.

The communication network 102 can be a wired/wireless communication network, and can include various communication networks, such as a Personal Area Network (PAN), a Local Area Network (LAN), a Metropolitan Area Network (MAN), and a Wide Area Network (WAN). Also, the communication network 102 can be a well-known World Wide Web (WWW) or can use wireless transmission technology for short-range communication, such as Infrared Data Association (IrDA) or Bluetooth. Also, the communication network 102 can include a cable broadcasting communication network, a terrestrial broadcasting communication network, and a satellite broadcasting communication network for receiving broadcasting signals.

As described above, according to an embodiment of the present disclosure, it is possible to provide a user with a more efficient payment method by combining an offline payment method using the member shop terminal 101 (e.g., a POS terminal) with an online payment method through the user terminal 100.

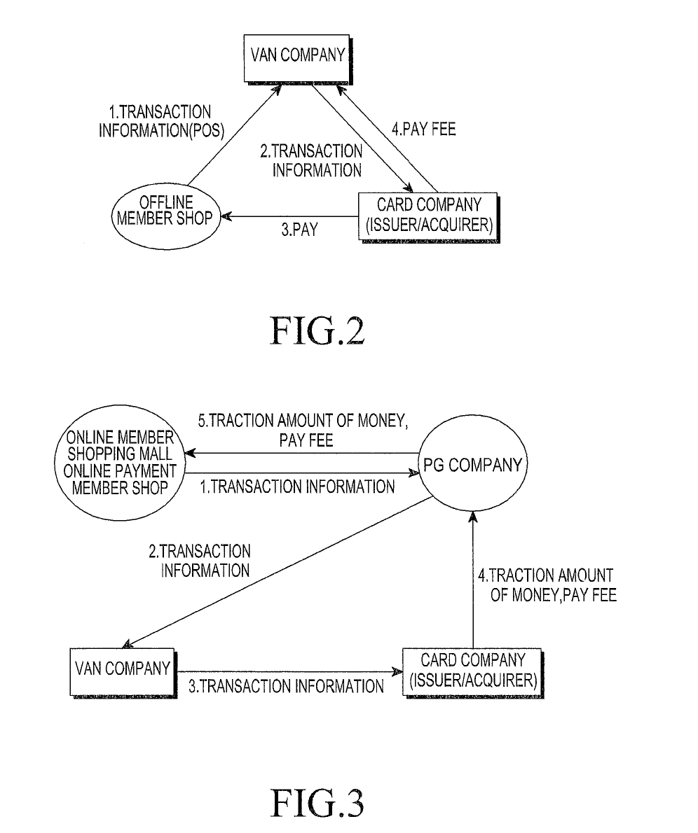

Hereinafter, for easy understanding of the present disclosure, examples of an offline payment method through a member shop terminal and an online payment method through a user terminal will be described with reference to FIGS. 2 and 3.

FIG. 2 illustrates a payment procedure through a member shop terminal. Referring to FIG. 2, if an offline member shop requests a card payment through a POS terminal, transaction information can be transmitted to the corresponding card company via a VAN company. Then, the card company can notify a transaction authorization to the POS terminal via the VAN company, and the member shop can sell a product or a service to a member customer since the corresponding card has been normally authorized.

Thereafter, the member shop can transmit a sales slip on which the member customer has written down his/her signature to the card company via the VAN company, and the card company can examine the sales slip received from the card member shop. If the card company determines that the sales slip has been normally processed, the card company can put the credit sales money into the member shop's account. Also, the card company can pay a predetermined payment gateway fee for the VAN company.

FIG. 3 is a view for describing an online payment procedure through the Internet. Referring to FIG. 3, in case of the online payment procedure, unlike the offline payment procedure, since credit card transactions are processed by receiving and transmitting credit card transactions information through the Internet, telephones, mails, etc. without a face-to-face between buyers and sellers, a Payment Gateway (PG) company can participate in a transaction process to perform a function similar to an offline VAN company in order to efficiently intermediate and secure information about credit card transactions.

For example, if a user requests an online payment at an online shopping mall, transaction information can be transmitted to a card company through a PG company and a VAN company. The card company can notify a transaction authentication to the online shopping mall through the PG company, and calculate a transaction amount of money, and a merchant fee.

Meanwhile, embodiments of the present disclosure provide a method of enabling an offline member shop to easily make a payment online through a user terminal by combining the offline payment method illustrated in. FIG. 2 with the online payment method illustrated in FIG. 3, and the method according to the embodiments of the present disclosure can be implemented through a system illustrated in FIG. 4.

FIG. 4 illustrates a payment system according to an embodiment of the present disclosure. Referring to FIG. 4, if a user ID is input to a member shop terminal 101 through a user terminal 100 or by inputting the user ID directly to the member shop terminal 101, the member shop terminal 101 can transmit the user ID to an electronic wallet server 103 through a payment gateway server 104. At this time, as described above, the member shop terminal 101 can transmit information about the member shop, information about an amount of payment, and information about a product to be purchased to the electronic wallet server 103, together with the user ID.

Meanwhile, the user ID can be input by various methods, as described above. For example, the user terminal 100 can transmit the user ID stored therein to the member shop terminal 101 through short-range wireless communication (e.g., NFC communication). As another example, a scanner included in the member shop terminal 101 can scan a barcode or a Quick Response (QR) code including the user ID, displayed on a screen of the user terminal 100.

As such, if payment-related information including the user ID is transmitted to the electronic wallet server 103, according to an embodiment of the present disclosure, the electronic wallet server 103 can provide payment-related information including information about available payment means, to the user terminal 100, with reference to member shop payment-related information of the member shop terminal 101, and user payment-related information of the user, stored to correspond to the user ID.

For example, the electronic wallet server 103 can search for the user's own cards, the user's own coupons, and discount information stored to correspond to the user ID, and determine whether the user's own cards, the user's own coupons, and the discount information are available at the member shop.

Then, the electronic wallet server 103 can extract cards, coupons, and discount information available at the member shop from among the user's own cards, the user's own coupons, and the discount information, according to the results of the determination, and transmit information about the extracted cards, information about the extracted coupons, and the extracted discount information to the user terminal 100. Also, according to an embodiment of the present disclosure, the electronic wallet server 103 can calculate a discount rate for each of the payment means by applying the user's own coupons and the user's own cards to the payment means, and recommend payment means providing a highest discount rate for the user. For example, if an amount of money to be paid for the corresponding product is lowest when a specific coupon is applied to a specific card, the electronic wallet server 103 can transmit information about the card and the coupon to the user terminal 100 in order to make an optimal payment.

According to another embodiment of the present disclosure, when the individual payment means available by the user have different discount rates or benefits that are provided by the corresponding member shop, the electronic wallet server 103 can provide information about payment means providing a highest discount rate or most benefits to the user terminal 100 in order to recommend the payment means for the user.

For example, according to an embodiment of the present disclosure, as described above, the electronic wallet server 103 can calculate a discount rate for each of the user's own payment means, extract optimal discount information for each of the user's own payment means, and then provide the optimal discount information to the user terminal 100. According to another embodiment of the present disclosure, the electronic wallet server 103 can extract optimal discount information for each of the payment means available at the corresponding member shop, and provide the optimal discount information to the user terminal 100. According to still another embodiment of the present disclosure, the electronic wallet server 103 can provide information about payment means capable of collecting most points to the user terminal 100.

If the payment-related information (or the optimal discount information) is transmitted to the user terminal 100, the user can see the payment-related information displayed on a screen of the user terminal 100, and select desired payment means to request a payment. The payment-related information that the user can see though the user terminal 100 can include information about the member shop, an amount of payment, information about the product, the user ID, available payment means (e.g., available cards), and information about available coupons.

If payment means and/or a coupon is selected through the user terminal 100, an online payment by the selected payment means and/or the selected coupon can be requested. Information for requesting the payment can be transmitted to the electronic wallet server 103.

According to another embodiment of the present disclosure, if the payment means (e.g., payment means providing a highest discount rate) by which the payment has been requested is not a payment means by which the user can pay, the user terminal 100 can perform a procedure for registering the payment means in order to request a payment by the selected payment means,

The electronic wallet server 103 can receive the information for requesting the payment from the user terminal 100, and perform a payment procedure according to the information for requesting the payment. If information about a coupon to be used is included in the information for requesting the payment, the electronic wallet server 103 can determine whether the coupon is available or usable, and then process the payment.

Meanwhile, if the payment means selected by the user is a mobile phone micro-payment service, the electronic wallet server 103 can request a communication company server 430 corresponding to the user's registered mobile phone to authorize a micro-payment for the user's mobile phone. The communication company server 430 can authorize the micro-payment for the user's mobile phone to thereby process the requested payment. Meanwhile, if the payment means selected by the user is a specific credit card, the electronic wallet server 102 can request a card company server 420 corresponding to the credit card to authorize a card payment.

At this time, the electronic wallet server 103 can process the payment with the communication company server 420 or the card company server 430 through a PG server 410. Accordingly, if the communication company or the card company authorizes the payment, the PG server 410 can process the authorization, and then transmit payment authorization information to the electronic wallet server 103. Thereafter, the electronic wallet server 103 can transmit the payment authorization information to the member shop terminal 101, and the member shop terminal 101 can finally authorize the payment, and output a receipt. Also, the electronic wallet server 103 can transmit the payment authorization information to the user terminal 100, and the user terminal 100 can display payment completion information on a screen.

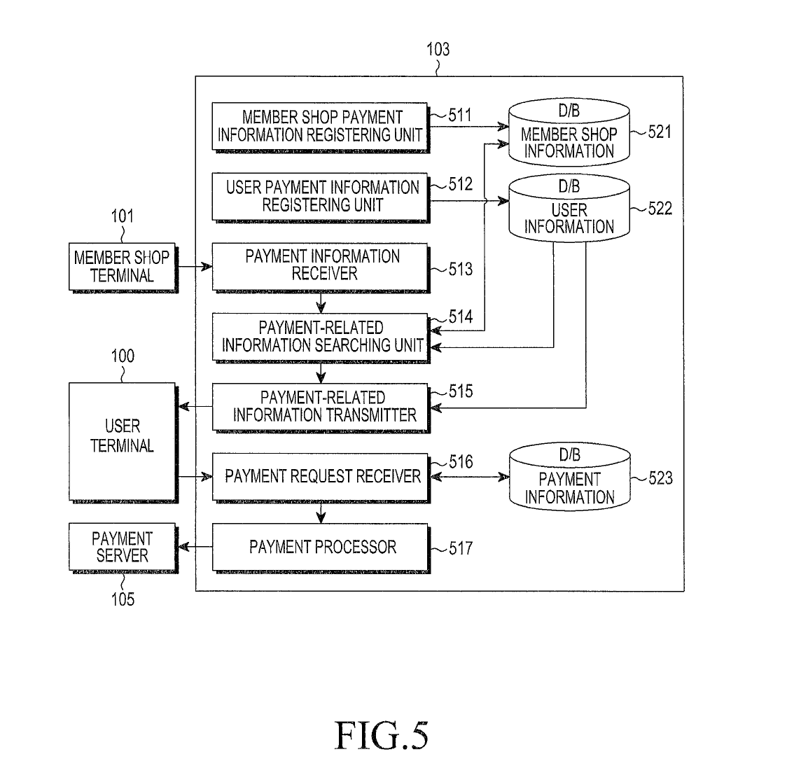

FIG. 5 is a block diagram illustrating a configuration of an electronic wallet server according to an embodiment of the present disclosure. Referring to FIG. 5, an electronic wallet server 103 can include a member shop payment information registering unit 511, a user payment information registering unit 512, a payment information receiver 513, a payment-related information searching unit 514, a payment-related information transmitter 515, a payment request receiver 516, and a payment processor 517. Also, the electronic wallet server 103 can further include at least one database, such as member shop information database 521, user information database 522, and payment information database 523. Meanwhile, each database can be included in the electronic wallet server 103, or constructed as a separate database server.

The member shop payment information registering unit 511 can store member shop payment-related information of member shops, including information about payment means available at the individual member shops, in the member shop information database 521. For example, basic information about member shops, such as names, telephone numbers, and addresses of the member shops, information about payment means (e.g., various kinds of credit cards, a mobile phone payment, etc.) available at the individual member shops, and information about discount rates, discount periods, and coupons that are provided by the individual member shops can be stored in the member shop information database 521.

The user payment information registering unit 511 can store user payment-related information of each user, including information about payment means available by the user, in the user information database 522. For example, basic information about users, such as IDs, names, phone numbers, and addresses of the users, information about available payment means (e.g., various kinds of credit cards, a mobile phone payment, etc.) registered by the individual users, and information about coupons that the individual users have can be stored in the user information database 522.

The payment information receiver 513 can receive payment-related information (e.g., information about a member shop, information about an amount of payment, and information about a product to be purchased) including a user ID, from a member shop terminal 101, as described above.

The payment-related information searching unit 514 can search for member shop payment-related information of the corresponding member shop and user payment-related information of the corresponding user, stored in the member shop information database 521 and the user information database 522, respectively. At this time, according to an embodiment of the present disclosure, the electronic wallet server 103 can provide information about payment means and/or coupons that the user corresponding to the user ID can use at the corresponding member shop, to a user terminal 100 of the user, based on the found information.

Accordingly, the payment-related information transmitter 515 can analyze the results of the search by the payment-related information searching unit 514, and transmit information about payment means available by the user to the user terminal 100.

Also, according to an embodiment of the present disclosure, the payment-related information transmitter 515 can analyze the results of the search by the payment-related information searching unit 514 to extract optimal discount information, and provide the optimal discount information to the user terminal 100.

For example, according to an embodiment of the present disclosure, the payment-related information transmitter 515 can calculate a discount rate for each of the user's own payment means to extract optimal discount information for each of the user's own payment means, and provide the optimal discount information to the user terminal 100. According to another embodiment of the present disclosure, the payment-related information transmitter 515 can extract optimal discount information for each of payment means available at the corresponding member shop, and provide the optimal discount information to the user terminal 100. According to still another embodiment of the present disclosure, the payment-related information transmitter 515 can provide information about payment means capable of collecting most points to the user terminal 100.

The above description relates to a case in which the payment-related information transmitter 515 calculates a discount rate for each of the user's own payment means to provide optimal discount information. However, embodiments of the present disclosure are not limited to the case, and the payment-related information transmitter 515 can provide various kinds of payment-related information that the user can refer to for a payment.

For example, the payment-related information transmitter 515 can compare payment conditions of various methods based on payment-related information collected for the corresponding user and the corresponding member shop, and provide payment-related information according to the results of the comparison to the user terminal 100 so that the user can request the payment using his/her most desired payment condition.

For example, the collected payment-related information can be information about the user's points to be collected according to the payment, information about discount rates of individual card companies, or information about a coupon (e.g., a gift coupon) of the corresponding member shop, which can be used for the payment. Accordingly, the electronic wallet server 103 can compare payment conditions (e.g., information about cards, discount information of the cards, information about available points, and information about available gift coupons) for paying for a product or a service (hereinafter, referred to as an “item”), and provide at least one payment-related information according to the results of the comparison to the user terminal 100.

As an example of comparing the payment conditions, the electronic wallet server 103 can compare amounts of payment by different kinds of payment means, compare amounts of payment by the same payment means according to different payment methods, compare an amount of payment when points are used to an amount of payment when no points are used, compare an amount of payment when a gift coupon is applied to an amount of payment when no gift coupon is applied, and compare the numbers of points to be collected upon a payment, in order to determine whether there is a payment condition more favorable to the user.

As another example of comparing the payment conditions, the electronic wallet server 103 can compare the payment conditions in consideration of payment means capable of collecting more points, whether a coupon can be applied, and whether two or more cards can be used together, in addition to comparing the amounts of payments.

Also, the electronic wallet server 103 can digitize the individual payment conditions to compare the digitized payment conditions. In this case, the electronic wallet server 103 can digitize the individual payment conditions after allocating a weight to a payment condition that the user prioritizes.

The electronic wallet server 103 can provide the user terminal 100 with information about at least one payment condition selected from among the payment conditions, according to a predetermined priority (e.g., a payment condition providing a lowest amount of payment, a payment condition capable of collecting most points, a payment condition allowing use of a coupon, or a payment condition providing a highest discount rate).

The user can check information about available payment means or at least one payment-related information (e.g., optimal discount information) displayed on a screen of the user terminal 100, and select a desired payment condition to request the payment. The payment request receiver 516 can receive the payment request from the user terminal 100, and perform a payment process with the corresponding payment server 105 through the payment processor 517. Information that is used in the payment process can be stored in the payment information database 523. For example, the payment information database 523 can store a date and a time of the payment, the user ID, information about the member shop, information about the corresponding item, and information about the amount of payment.

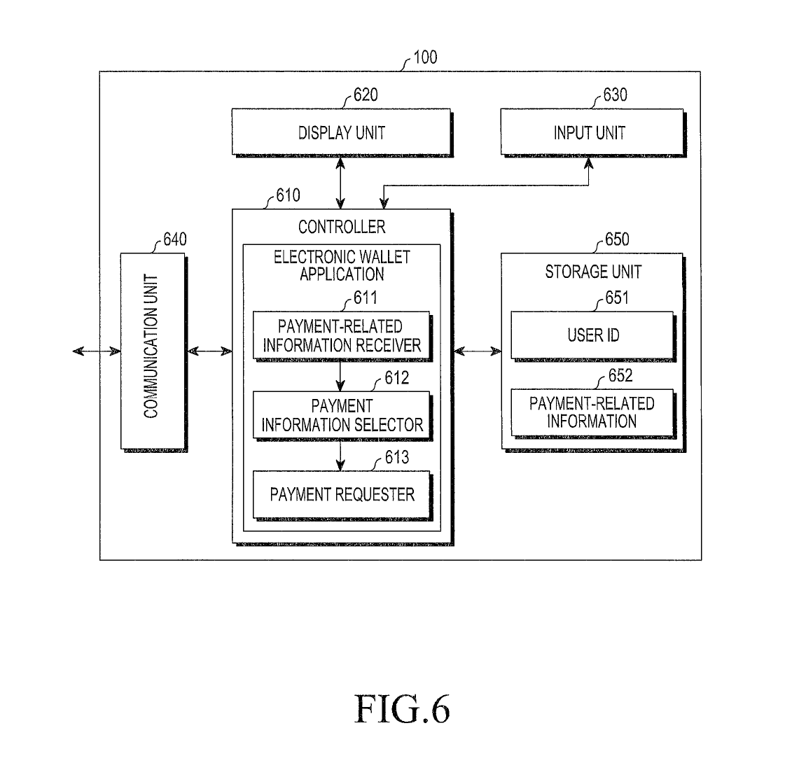

FIG. 6 is a block diagram illustrating a configuration of a user terminal according to an embodiment of the present disclosure. Referring to FIG. 6, a user terminal 100 can include a controller 610, a display unit 620, an input unit 630, a communication unit 640, and a storage unit 650.

An electronic wallet application can be installed and executed in the controller 610 in order for the controller 610 to perform various functions related to embodiments of the present disclosure through the electronic wallet application. The electronic wallet application can include a payment-related information receiver 611, a payment information selector 612, and a payment requester 613.

The storage unit 650 can store a user ID 651 and at least one payment-related information 652.

As described above, the user ID 651 stored in the storage unit 650 of the user terminal 100 can be displayed in the form of a barcode through the display unit 620. The user ID 651 can be transmitted to the member shop terminal 101 (see FIG. 1) through the communication unit 640.

The payment-related information receiver 611 can receive information about payment means available at the corresponding member shop or optimal discount information from the electronic wallet server 103 (See FIG. 5), and the received information about payment means or the received optimal discount information can be displayed through the display unit 620.

The payment information selector 612 can select payment information according to payment means selected by a user through the input unit 630. The payment requester 613 can request a payment by the payment means selected through the payment information selector 612. Information for requesting the payment can be transmitted to the electronic wallet server 103 to perform online payment processing.

According to another embodiment of the present disclosure, if the payment means (e.g., a payment means providing a highest discount rate) by which the payment has been requested is not a payment means by which the user can pay, the electronic wallet application installed in the user terminal 100 can perform a procedure for registering the payment means in order to request a payment by the selected payment means.

Meanwhile, each functional unit and each module in embodiments of the present disclosure can mean functional and structural combination of software to run hardware to perform technical idea of the embodiments of the present disclosure and the hardware. For example, the functional unit can mean a logical unit of hardware resource to perform predetermined code and the predetermined code, and the fact that it does not always mean a code physically connected or one kind of hardware can be easily deducted by normal experts in this technical field of the embodiments of the present disclosure.

Hereinafter, methods according to embodiments of the present disclosure will be described in detail with reference to FIGS. 7 to 11.

FIG. 7 is a flowchart illustrating a method of making a payment using an electronic wallet, according to an embodiment of the present disclosure. Referring to FIG. 7, a user ID can be input to a member shop terminal 101 through a user terminal 100 or by inputting the user ID directly to the member shop terminal 101 (operation 702), and the member shop terminal 101 can request an electronic wallet server 103 to perform payment processing (operation 704). According to an embodiment of the present disclosure, payment-related information can be transmitted to the electronic wallet server 103 (operation 706). The payment-related information can include the user ID, and can further include information about the member shop, information about an amount of payment, and information about an item to be purchased.

The electronic wallet server 103 can receive the payment-related information from the member shop terminal 101, and search for information about payment means available at the member shop and information about payment means available by the user (operations 708 and 710). Then, the electronic wallet server 103 can create payment-related information including information about payment means by which the user can pay at the member shop, discount information, and coupon information, with reference to the found information about payment means available at the member shop and the found information about payment means available by the user (operation 712), and transmit the payment-related information to the user terminal 100 of the user (operation 714).

The user terminal 100 can display the payment-related information received from the electronic wallet server 103 on a screen (operation 716). When the user selects payment means (operation 718), the user terminal 100 can request the electronic wallet server 103 to make the payment by the selected payment means (operation 720).

The electronic wallet server 103 can process the payment according to the payment request from the user terminal 100 (operation 722). For example, the electronic wallet server 103 can request a payment server 105 to make the payment (operation 724), and the payment server 105 can process the payment according to the payment request from the electronic wallet server 103 (operation 726), and then perform a payment procedure with at least one of the electronic wallet server 103, the user terminal 100, and the member shop terminal 101 (operation 728).

If the payment process is completed, the electronic wallet server 103 can transmit the result of the payment to the user terminal 100 and/or the member shop terminal 101 (operations 730 and 732).

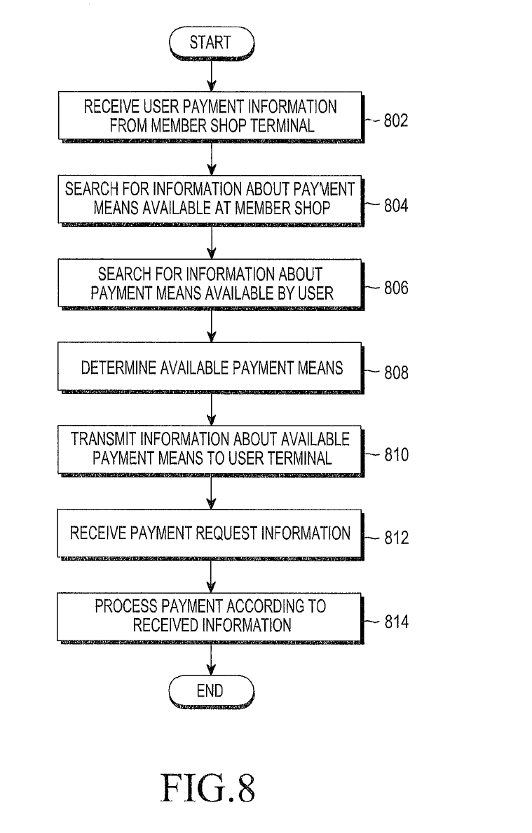

FIG. 8 is a flowchart illustrating a method in which an electronic wallet server processes a payment, according to an embodiment of the present disclosure. Referring to FIG. 8, if an electronic wallet server receives payment information including a user ID from a member shop terminal (operation 802), the electronic wallet server can search for information about payment means available at the corresponding member shop and information about payment means available by the corresponding user (operations 804 and 806).

Then, the electronic wallet server can extract payment means that the user can use at the member shop, from the found information about payment means available at the member shop and the found information about payment means available by the user, and determine at least one available payment means from among the extracted payment means (operation 808). Successively, the electronic wallet server can transmit information about the determined available payment means to a user terminal of the user (operation 810).

Meanwhile, if information for requesting a payment by selected payment means is received from the user terminal (operation 812), the electronic wallet server can process the payment by the selected payment means with reference to the received information (operation 814).

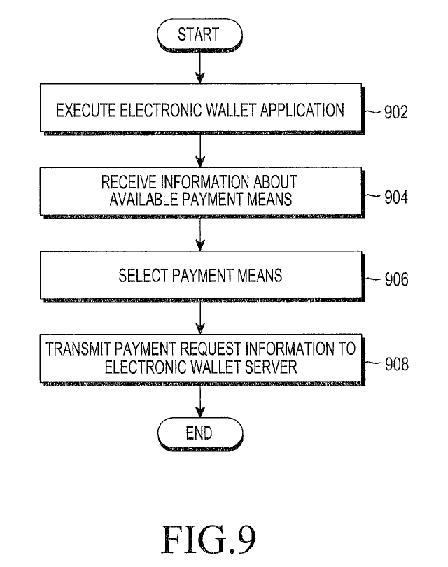

FIG. 9 is a flowchart illustrating a method in which a user terminal processes a payment, according to an embodiment of the present disclosure. Referring to FIG. 9, a user terminal can install an electronic wallet application therein and execute the electronic wallet application (operation 902). Thereafter, the user terminal can receive information about available payment means from an electronic wallet server (operation 904). If a user selects payment means (operation 906), the user terminal can transmit payment request information including information about the selected payment means to the electronic wallet server (operation 908).

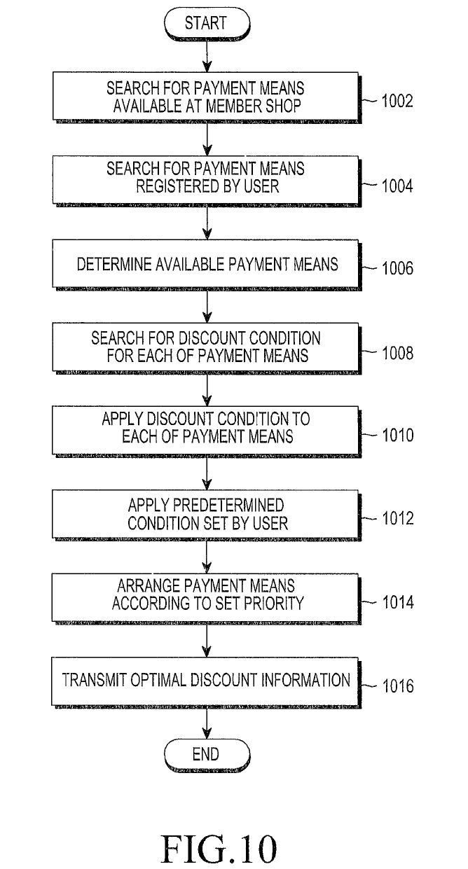

FIG. 10 is a flowchart illustrating a method in which an electronic wallet server provides payment information, according to an embodiment of the present disclosure. Referring to FIG. 10, an electronic wallet server can receive payment information including a user ID from a member shop terminal, and search for payment means available at the corresponding member shop (operation 1002).

Also, the electronic wallet server can search for payment means registered by the user (operation 1004), and determine at least one payment means that the user can use at the member shop (operation 1006).

At this time, according to an embodiment of the present disclosure, the electronic wallet server can search for a discount condition for each of the payment means (operation 1008), and apply the discount condition to the payment means to calculate a discount amount of payment for each of the payment means (operation 1010).

According to another embodiment of the present disclosure, the electronic wallet server can apply a predetermined condition set by the user to each of the payment means (operation 1012). For example, the user can set at least one of a condition of preferentially using predetermined payment means, a condition of preferentially using predetermined payment means with respect to a predetermined item, a condition of preferentially using predetermined payment means with respect to a predetermined member shop, and a condition of not using predetermined payment means or not using points with respect to a predetermined item

The electronic wallet server can arrange the payment means according to a priority set as described above (operation 1014), or can arrange the payment means according to a priority set in further consideration of a condition(s) set in advance by the user. Then, the electronic wallet server can transmit optimal discount information to the user terminal 100, based on the result of the arrangement of the payment means according to the priority (operation 1016).

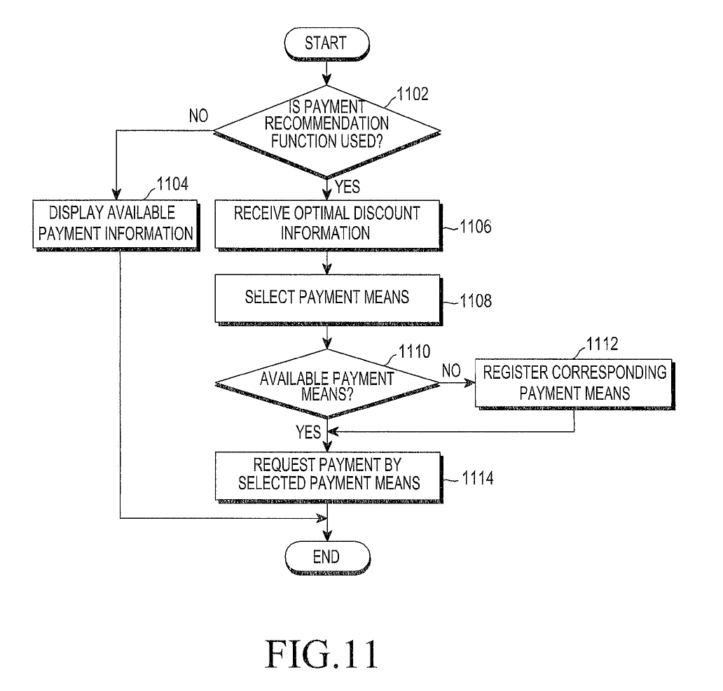

FIG. 11 is a flowchart illustrating a method in which a user terminal provides payment information, according to another embodiment of the present disclosure. Referring to FIG. 11, a user terminal can determine whether or not to use a payment recommendation function (operation 1102). If the user terminal does not use the payment recommendation function (“NO” in operation 1102), according to an embodiment of the present disclosure, the user terminal can display information about at least one available payment information based on payment-related information received from an electronic wallet server on a screen (operation 1104). Thereafter, a user can select desired payment means to request a payment.

Meanwhile, if the user terminal uses the payment recommendation function (“YES” in operation 1102), according to another embodiment of the present disclosure, the user terminal can receive optimal discount information from the electronic wallet server 103 (operation 1106). Thereafter, the user can select desired payment means (operation 1108).

Then, the user terminal can determine whether the selected payment means is available payment means registered by the user (operation 1110). If the user terminal determines that the selected payment means is available payment means registered by the user (“YES” in operation 1110), the user terminal can request a payment by the selected payment means (operation 1114). However, if the user terminal determines that the selected payment means is nonregistered or unavailable payment means, the user terminal can register the corresponding payment means (operation 1112).

The methods of providing the payment information using the electronic wallet, according to the various embodiments of the present disclosure, can be implemented as computer-executable programs executable by various computational devices and stored in computer-readable recording medium. The computer readable recording medium can include a program command, a data file, a data structure, or a combination thereof. The program command written to the computer readable recording medium can be specially designed and configured or can be already known to those skilled in the field of computer software. Examples of the computer readable recording medium include magnetic storage media (e.g., hard disks, floppy disks, and magnetic taps), optical recording media (e.g., Compact Disc (CD)-Read Only Memories (ROMs) and Digital Versatile Discs (DVDs)), magneto-optical storage media (e.g., floptical disks), and hardware devices (e.g., ROMs, Random-Access Memories (RAMs), and flash memories) configured to store and execute program commands. Program commands can include, for example, a high-level language code that can be executed by a computer using an interpreter, as well as a machine language code made by a complier. The hardware devices can be configured to be operated by one or more software modules to implement the present disclosure, and vice versa.

Also, the user terminal according to the embodiment of the present disclosure can be implemented as one of various electronic devices. An example of such electronic devices can be a smart phone.

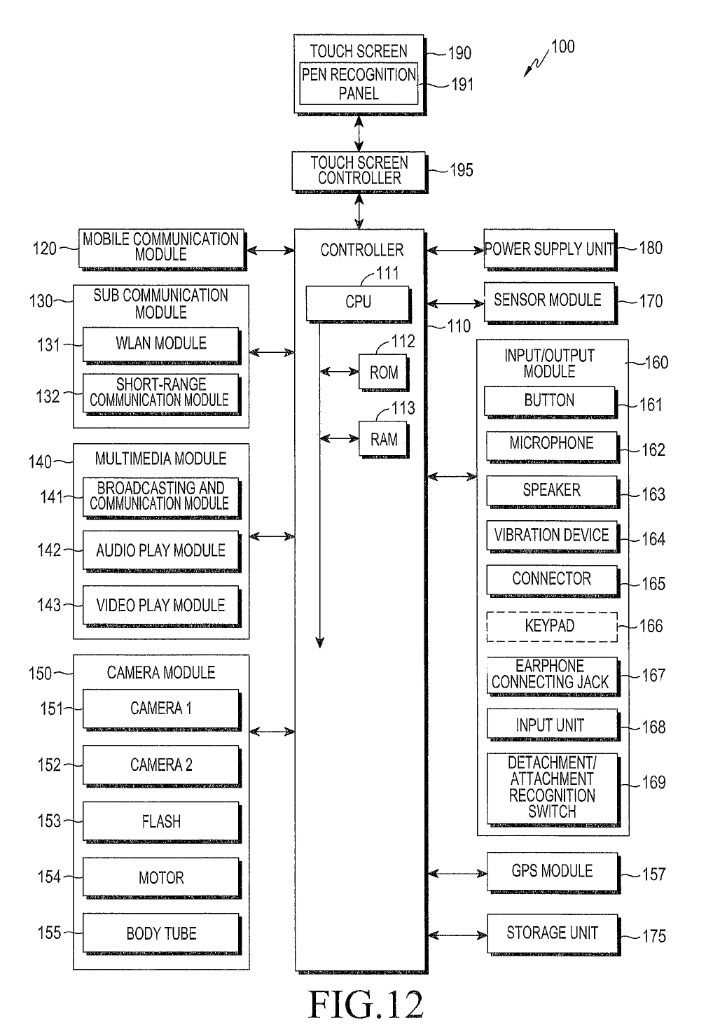

FIG. 12 is a block diagram illustrating a configuration of a user terminal according to another embodiment of the present disclosure. Referring to FIG. 12, a user terminal 100 can include at least one of a controller 110, a mobile communication module 120, a multimedia module 140, a camera module 150, an input/output module 160, a sensor module 170, a state indicator 171, a storage unit 175, a power supply unit 180, and a touch screen 190.

In more detail, the user terminal 100 can connect to an external electronic device (not shown) using at least one of the mobile communication module 120, a connector 165, and an earphone connecting jack 167. Also, user terminal 100 can connect to another mobile device or another electronic device, for example, one of a mobile phone, a smart phone, a tablet PC, a desktop PC, and a server, in a wired/wireless fashion.

Communication modules can include the mobile communication module 120, a sub communication module 130, and a broadcasting and communication module 141. The sub communication module 130 can include at least one of a Wireless Local Area Network (WLAN) module 131 and a short-range communication module 132. The multimedia module 140 can include at least one of the broadcasting and communication module 141, an audio play module 142, and a video play module 143. The camera module 150 can include at least one of a first camera 151 and a second camera 152. Also, the camera module 150 can further include a flash 153, a motor 154, and a body tube 155. The input/output module 160 can include at least one among one or more buttons 161, at least one microphone 162, at least one speaker 163, at least one vibration device 164, the connector 165, and a keypad 166.

The controller 110 can include a Central Processing Unit (CPU) 111, a ROM 112 that stores control programs for controlling the user terminal 100, and a RAM 113 that stores signals/data received from an external device or tasks being executed by the user terminal 100. The CPU 111 can be a single-core processor or a multi-core processor (e.g., a dual-core processor, a triple-core processor, or a quad-core processor). The CPU 111, the ROM 112, and the RAM 113 can be connected to each other through internal buses.

The controller 110 can control at least one of the mobile communication module 120, the multimedia module 140, the camera module 150, the input/output module 160, the sensor module 170, the storage unit 175, the power supply unit 180, the touch screen 190, and the touch screen controller 195.

According to an embodiment of the present disclosure, the controller 110 can install, as illustrated in FIG. 6, an electronic wallet application to provide various functions according to the various embodiments of the present disclosure.

When the input unit 168 approaches the touch screen 190 or is placed in proximity to the touch screen 190, the controller 110 can sense a user input event such as a hovering event. Also, the controller 110 can detect various user inputs received through the camera module 150, the input/output module 160, and the sensor module 170, as well as the touch screen 190. The user input can include various kinds of information input to the user terminal 100, such as the user's gesture, the user's voice, the user's eye movements, the user's iris recognition, and a physiological signal from the user, as well as a touch operation. The controller 110 can control the user terminal 100 to perform a predetermined operation or function corresponding to the detected user input. Also, the controller 110 can output a control signal to the input unit 168 or the vibration device 164. The control signal can include information about a vibration pattern, and the input unit 168 or the vibration device 164 can generate vibration according to the vibration pattern.

Also, the user terminal 100 can include at least one of the mobile communication module 120, a WLAN module 131, and a short-range communication module 132, according to performance.

The mobile communication module 120 enables the user terminal 100 to connect to an external device through mobile communication using at least one antenna (not shown) under the control of the controller 110. The mobile communication module 120 can transmit/receive radio signals for voice calls, video calls, Short Message Service (SMS), or Multimedia Message Service (MMS) with a device (not shown) such as a mobile phone, a smart phone, a tablet PC, or another electronic device having a phone number input to the user terminal 100, to/from the user terminal 100.

The sub communication module 130 can include, as described above, at least one of the WLAN module 131 and the short-range communication module 132. For example, the sub communication module 130 can include only the WLAN module 131, only the short-range communication module 132, or both the WLAN module 131 and the short-range communication module 132.

The WLAN module 131 can connect to the Internet at a place in which a wireless Access Point (AP) is installed, under the control of the controller 110. The WLAN module 131 supports IEEE802.11x. The short-range communication module 132 can perform wireless short-range communication between the user terminal 100 and an external electronic device under the control of the controller 110. The short-range communication can include Bluetooth, InfraRed Data Association (IrDA), WiFi-Direct communication, and Near Field Communication (NFC).

The broadcasting communication module 141 can receive broadcasting signals (for example, TV broadcasting signals, radio broadcasting signals, or data broadcasting signals) and broadcasting additional information (for example, an Electric Program Guide (EPS) or an Electric Service Guide (ESG)) transmitted from a broadcast station through a broadcasting communication antenna (not shown), under the control of the controller 110.

The multimedia module 140 can include the audio play module 142 or the video play module 143. The audio play module 142 can reproduce a digital audio file (e.g., a file having the filename extension of “.mp3”, “.wma”, “.ogg”, or “.wav”, for example) that is stored in the storage unit 175 or received, under the control of the controller 110. The video play module 143 can reproduce a digital video file (for example, a file having the filename extension of “.mpeg”, “.mpg” “.mp4”, “.avi”, “.mov”, or “.mkv”, for example) or a digital audio file that is stored or received under the control of the controller 110. The multimedia module 140 can be integrated into the controller 110.

The camera module 150 can include at least one of the first camera 151 and the second camera 152 for photographing still images, moving images, or panorama images under the control of the controller 110. Also, the camera module 150 can also include at least one among the body tube 155 for zooming in/out to photograph a subject, the motor unit 154 for controlling movements of the body tube 155, and the flash 153 for providing a secondary light source required for photographing the subject. The first camera 151 can be disposed in the front side of the user terminal 100, and the second camera 152 can be disposed in the rear side of the user terminal 100.

The input/output module 160 can include at least one among the buttons 161, the microphone 162, the speaker 163, the vibration device 164, the connector 165, the key pad 166, the earphone connecting jack 167, and the input unit 168. However, the input/output module 160 is not limited to the above-mentioned devices, and a cursor control, such as a mouse, a trackball, a joystick, or cursor direction keys, can also be provided to control the movement of a cursor on the touch screen 190.

The buttons 161 can be provided in the front, side, and/or rear part of the housing of the user terminal 100. The buttons 161 can include at least one of a power/lock button (not shown), volume buttons (not shown), a menu button (not shown), a home button (not shown), a back button (not shown), a search button (not shown). The microphone 162 can receive voice or sound under the control of the controller 110 to generate an electrical signal. The speaker 163 receives sound corresponding to various signals or data (e.g., radio data, broadcasting data, digital audio data, or digital video data) to the outside of the user terminal 100, under the control of the controller 110. Also, the speaker 163 can output sound (e.g., button sounds, currency connection sounds, or the other party user's voice) corresponding to a function that is performed by the user terminal 100. The speaker 163 can be provided as at least one unit at an appropriate location (or locations) on the housing of the user terminal 100.

The vibration motor 164 converts an electrical signal into mechanical vibration under the control of the controller 110. For example, when the user terminal 100 is in a vibration mode, the vibration device 164 operates if a voice call or a video call is received from another device (not shown). The vibration device 164 can be provided as at least one unit in the housing of the user terminal 100. The vibration device 164 can operate in response to a user's input to the touch screen 190.

The connector 165 can be used as an interface for connecting the user terminal 100 to an external electronic device (not shown) or a power source (not shown). The controller 110 can transmit data stored in the storage unit 175 of the user terminal 100 to an external electronic device (not shown) through a wired cable connected to the connector 165, or the controller 110 can receive data of an external electronic device through the wired cable connected to the connector 165. The user terminal 100 can receive power or charge a battery (not shown) from a power source (not shown) through the wired cable connected to the connector 165.

The keypad 166 can receive key input from a user in order to control the user terminal 100. The keypad 166 can include a physical keypad (not shown) that is provided on the user terminal 100, or a virtual keypad (not shown) that is displayed on the touch screen 190. The user terminal 100 can include no physical keypad according to a structure of the user terminal 100. The earphone (not shown) can be inserted into the earphone connecting jack 167 to connect to the user terminal 100.

The input unit 168 can be inserted into and held in the user terminal 100, and when in use, the input unit 168 can be drawn or separated from the user terminal 100. A detachment/attachment recognition switch 169 that operates in correspondence to attachment and detachment of the input unit 168 can be provided in an area of the user terminal 100 into which the input unit 168 is inserted. The detachment/attachment recognition switch 169 can output a signal corresponding to attachment/separation of the input unit 168 to the controller 110. The detachment/attachment recognition switch 169 can be configured to directly or indirectly contact the input unit 168 when the input unit 169 is attached in the user terminal 100. Accordingly, the detachment/attachment recognition switch 169 can generate a signal (i.e., a signal for notifying attachment or separation of the input unit 168) corresponding to attachment or separation of the input unit 168 based on whether the detachment/attachment recognition switch 169 contacts the input unit 168, and outputs the signal to the controller 110.

The sensor module 170 can include at least one sensor for detecting a status of the user terminal 100. For example, the sensor module 170 can include at least one sensor among a proximity sensor (not shown) for determining whether a user approaches the user terminal 100, an ambient light sensor (not shown) for measuring an amount of ambient light around the user terminal 100, a motion sensor (not shown) for detecting motion (rotation, acceleration, or vibration) of the user terminal 100, a geo-magnetic sensor (not shown) for detecting a point of the compass of the user terminal 100 using the earth's magnetic field, a gravity sensor (not shown) for detecting a direction in which gravity is applied, an altimeter (not shown) for measuring atmospheric pressure to detect an altitude, and a GPS module 157.

The GPS module 157 can receive radio waves from a plurality of GPS satellites (not shown) on the orbit around the earth, and calculate the location of the user terminal 100 based on a time of arrival of the radio waves from the GPS satellites to the user terminal 100.

The storage unit 175 can store signals or data that is input/output according to operations of the mobile communication module 120, the multimedia module 140, the camera module 150, the input/output module 160, the sensor module 170, and the touch screen 190, under the control of the controller 110. Also, according to an embodiment of the present disclosure, as illustrated in FIG. 6, the storage unit 175 can store a user ID or payment-related information.

The storage unit 175 can store control programs and applications for controlling the user terminal 100 or the controller 110. For example, the storage unit 175 can store an electronic wallet application installed in the user terminal 100.

In this description, the term a “storage unit” includes the storage unit 175, the ROM 112 or RAM 113 included in the controller 110, and a memory card (not shown, for example, a Secure Digital (SD) card or a memory stick) installed in the user terminal 100. The storage unit 175 can include a non-volatile memory, a volatile memory, a Hard Disk Drive (HDD), or a Solid State Drive (SSD).

The storage unit 175 can store applications with various functions, such as navigation, a video call, games, a time-based alarm application, etc., images for providing a user with Graphic User Interfaces (GUIs) associated with the applications, user information, document, databases or data related to a method of processing touch inputs, background images (a menu screen, a lock screen, etc.) or operation programs required to drive the user terminal 100, images photographed by the camera module 150, etc.

The storage unit 175 can be machine (for example, a computer)-readable media, and the term “machine-readable media” can be defined as media of providing data to a machine so that the machine can perform a specific function. The storage unit 175 can include non-volatile media and volatile media. Such a medium needs to be of a tangible type so that commands delivered to the medium can be detected by a physical tool which reads the commands with the machine.

The machine-readable media can include at least one among a floppy disk, a flexible disk, a hard disk, a magnetic tape, a Compact Disc Read-Only Memory (CD-ROM), an optical disk, a punch card, a paper tape, a RAM, a Programmable Read-Only Memory (PROM), an Erasable PROM (EPROM), a FLASH-EPROM, and an embedded Multi Media Card (eMMC)

The power supply unit 180 can supply power to one or more batteries installed in the housing of the user terminal 100 under the control of the controller 110. The one or more batteries supply power to the user terminal 100. The power supply unit 180 can supply power received from an external power source to the user terminal 100 through a wired cable connected to the connector 165. The power supply unit 180 can supply power received wirelessly from an external power source to the user terminal 100 through wireless charging technology.

The user terminal 100 can include at least one touch screen 190 that provides a user with GUIs corresponding to various services (for example, a call, data transmission, broadcasting, and photographing). The touch screen 190 can output an analog signal corresponding to at least one user input inputted to a GUI to the touch screen controller 195.

The touch screen 190 can receive at least one user input through a user's body part (for example, a finger including a thumb) or the input unit 168 (for example, a stylus pen or an electronic pen). The touch screen 190 can be a resistive touch screen, a capacitive touch screen, an infrared touch screen, an acoustic wave touch screen, or a combination thereof.

The touch screen 190 can also include at least two touch panels for respectively sensing touches or approaches of a finger and the input unit 168 so as to respectively receive inputs by the finger and the input unit 168. The at least two touch panels provide different output values to the touch screen controller 195, and the touch screen controller 195 recognizes the different output values received from the at least two touch panels to determine whether an input to the touch screen 190 is an input by a finger or an input by the input unit 168.

In this specification, the term “touch” is not limited to a contact of a user's body part or a pointing device to the touch screen 190, and can include non-contact recognition (for example, when a user's body part or a pointing device is located within a recognition distance (for example, 1 mm) in which the user's body part or the pointing device can be detected without a direct contact to the touch screen 190). The recognition distance in which the touch screen 190 can recognize the user's body part or the pointing device can depend on the performance or structure of the user terminal 100.

The touch screen controller 195 can convert an analog signal received from the touch screen 190 into a digital signal, and transfers the digital signal to the controller 110. The controller 110 can control the touch screen 190 using the digital signal received from the touch screen controller 195. The touch screen controller 195 can detect a value (for example, a current value) output through the touch screen 190 to determine an hovering interval or distance as well as a user's input location, convert the determined distance value into a digital signal (for example, a z coordinate), and then provide the digital signal to the controller 110. The touch screen controller 195 can detect a value (for example, a current value) output through the touch screen 190 to estimate pressure with which a user input device presses the touch screen 190, convert the estimated pressure value into a digital signal, and then provide the digital signal to the controller 110.

Therefore, according to the embodiments of the present disclosures, it is possible to increase usability of an electronic wallet by providing a user with information about an optimal discount price when he/she purchases a product or a service, and providing the user with a route for registering a card providing the optimal discount price when he/she does not possess the corresponding card.

Although the present disclosure has been described with an exemplary embodiment, various changes and modifications may be suggested to one skilled in the art. It is intended that the present disclosure encompass such changes and modifications as fall within the scope of the appended claims.

What is claimed is:

1. A method for supporting electronic payment using an electronic wallet, the method comprising:
receiving user payment-related information including a user identifier from a shop terminal, according to a request for paying for an item;
determining at least one payment mean available at the shop terminal based on a shop payment-related information;
determining at least one payment condition for the item with respect to at least one payment mean; and
transmitting at least one payment condition selected from among the at least one payment condition according to a predetermined priority, to the user terminal.

2. The method of claim 1, wherein the user payment-related information received from the shop terminal includes at least one of the user identifier, information on the shop terminal, information on an amount of payment, information about the item, and information on payment means.

3. The method of claim 1, wherein the at least one payment condition is determined in consideration of at least one of information on cards, discount information of the cards, information about available points, and information about available gift coupons.

4. The method of claim 1, further comprising comparing the at least one payment conditions;
wherein the at least one payment conditions comprises one selected from among comparing amounts of payment by different kinds of payment means, comparing amounts of payment by the same payment means according to different payment methods, comparing an amount of payment when points are used to an amount of payment when no points are used, comparing an amount of payment when a gift coupon is applied to an amount of payment when no gift coupon is applied, and comparing the numbers of points to be collected upon a payment.

5. The method of claim 1, further comprising comparing the at least one payment conditions;
wherein the comparing of the at least one payment conditions comprises digitizing the at least one payment conditions to compare the digitized payment conditions.

6. The method of claim 5, wherein comparing the at least one payment conditions comprises digitizing the at least one payment conditions after allocating a weight to the at least one payment condition.

7. The method of claim 1, wherein the predetermined priority is at least one payment condition selected from among a payment condition providing a lowest amount of payment, a payment condition capable of collecting most points, a payment condition allowing use of a coupon, and a payment condition providing a highest discount rate.

8. An electronic wallet server comprising:
a shop information database configured to store shop payment-related information of at least one shop;
a user information database configured to store user payment-related information of each user to correspond to a user identifier allocated to the user;
a transceiver configured to receive user payment-related information including the user identifier from a shop terminal, according to a request for paying for a item; and
a controller configured to determine at least one payment mean available at the shop terminal, based on a shop payment-related information, determine at least one payment condition for the item with respect to at least one payment mean, and transmit at least one payment condition according to a predetermined priority, to a user terminal.

9. The electronic wallet server of claim 8, wherein the user payment-related information received from the shop terminal includes at least one of the user identifier, information on the shop terminal, information on an amount of payment, information about the item, and information on payment means.

10. The electronic wallet server of claim 8, wherein the controller is configured to determine the at least one payment condition in consideration of at least one of information on cards, discount information of the cards, information about available points, and information about available gift coupons.

11. The electronic wallet server of claim 8, wherein the controller is configured to compare the at least one payment condition by one selected from among comparing amounts of payment by different payment means, comparing amounts of payment by the same payment means according to different payment methods, comparing an amount of payment when points are used to an amount of payment when no points are used, comparing an amount of payment when a gift coupon is applied to an amount of payment when no gift coupon is applied, and comparing the numbers of points to be collected upon a payment.

12. The electronic wallet server of claim 8, wherein the controller is configured to digitize the at least one payment condition to compare the digitized payment conditions.

13. The electronic wallet server of claim 8, wherein the controller is configured to digitize the at least one payment condition after allocating a weight to the at least one payment condition.

14. The electronic wallet server of claim 8, wherein the predetermined priority is at least one payment condition selected from among a payment condition providing a lowest amount of payment, a payment condition capable of collecting most points, a payment condition allowing use of a coupon, and a payment condition providing a highest discount rate.

15. A computer-readable recording medium storing a program for causing a computer to execute a method, the method comprising:
receiving user payment-related information including a user identifier from a shop terminal, according to a request for paying for an item;
determining at least one payment mean available at the shop terminal based on a shop payment-related information;
determining at least one payment condition for the item with respect to at least one payment mean; and
transmitting at least one payment condition selected from among the at least one payment condition according to a predetermined priority, to the user terminal.

16. The computer-readable recording medium of claim 15, wherein the user payment-related information received from the shop terminal includes at least one of the user identifier, information on the shop terminal, information on an amount of payment, information about the item, and information on payment means.

17. The computer-readable recording medium of claim 15, wherein the at least one payment condition is determined in consideration of at least one of information on cards, discount information of the cards, information about available points, and information about available gift coupons.

18. The computer-readable recording medium of claim 15, wherein the method further comprises comparing the at least one payment conditions, wherein the at least one payment conditions comprises one selected from among comparing amounts of payment by different kinds of payment means, comparing amounts of payment by the same payment means according to different payment methods, comparing an amount of payment when points are used to an amount of payment when no points are used, comparing an amount of payment when a gift coupon is applied to an amount of payment when no gift coupon is applied, and comparing the numbers of points to be collected upon a payment.

19. The computer-readable recording medium of claim 15, further comprising comparing the at least one payment conditions;
wherein the comparing of the at least one payment conditions comprises digitizing the at least one payment conditions to compare the digitized payment conditions.

20. The computer-readable recording medium of claim 15, wherein comparing the at least one payment conditions comprises digitizing the at least one payment conditions after allocating a weight to the at least one payment condition.
